(19) United States
(12) Patent Application Publication
(10) Pub. No.: US 2018/0039985 A1
(43) Pub. Date: Feb. 8, 2018

(54) APPARATUS AND RELATED METHOD FOR DEVICE COMMUNICATION MANAGEMENT FOR TRANSMISSION OF SENSITIVE DATA

(71) Applicant: Ciphertronics, Inc., Carson City, NV (US)

(72) Inventors: Thomas A. Siegler, Charlotte, NC (US); Christopher M. Gowins, Yorba Linda, CA (US)

(73) Assignee: Ciphertronics, Inc., Carson City, NV (US)

(21) Appl. No.: 15/227,867

(22) Filed: Aug. 3, 2016

(51) Int. Cl. G06Q 20/40

(52) U.S. Cl. CPC G06Q 20/405; G06Q 20/401

(57) ABSTRACT

An apparatus and related method are provided for managing of peripheral devices and communication of sensitive data, such as, payment transactions in a manner that satisfies security concerns while minimizing maintenance of sensitive data by point-of-sale providers, which can be achieved by reducing or eliminating direct connections from internal networks to workstations and devices, and using a dedicated secure communications link for updates and processing of all sensitive data. In this manner, the system and related method reduces risk of system compromise and maintenance overhead.

### FIELD OF THE INVENTION

The present invention relates generally to processing transactions and managing devices and, more particularly, to transmission of sensitive data such as in electronic payment transactions.

### BACKGROUND OF THE INVENTION

Electronic payment transactions are ubiquitous. A consumer engages in such transactions in wide variety of environments, such as, self-service kiosks, operator-attended workstations, call-centers, and others. Payment can be initiated via credit card, debit card, check, among others. Various payment devices can be use to process payment.

Given the inherit risk of fraud with such transactions, a Payment Card Industry Security Standards Council (“PCI Council’), was formed by major players of the credit card industry. The PCI Council sets forth industry standards for data security standards known as the Payment Card Industry Data Security Standard (PCI DSS) and the Payment Card Industry PIN Transaction Security/Point of Interaction (PCI PTS/POI). These standards include multiple requirements and directives for those who process electronic transactions, particularly in which sensitive data is accessed and maintained and for the devices used in those transactions.

With reference now to FIG. 4, a typical prior-art system is shown for accepting payment at a point of sale (POS), which is authorized via a payment processor 401. A vendor will typically have a POS workstation 403 that provides devices (e.g., 406, 407, 408) though which a payment means of a payer 418 can be captured. Devices 406, 407, 408 include any of a PIN pad, signature capture, or card reader. The payer 418 will respond to messages 410, 412, 414, sent from the application 404. Any of devices 406, 407, 408 may be “purchaser activated” or activated by an operator of the POS workstation.

Upon successful capture of payer 418 data, devices 406, 407, 408 format a message 409, 411, 413 and send said message to workstation 403. Upon receipt, workstation 403 processes the transaction and sends authorization request message 415 through network 402 to payment processor 401.

In a typical embodiment, the workstation 403, software 404 and 405, and network 402 process “sensitive data” that is captured during the transaction such as cardholder data used to complete a payment. Said data may be acquired without encryption. In some embodiments, sensitive data is encrypted by the application 404 in the workstation 403 before transmitting message 415 to network 402. Alternatively, data may be encrypted by the device 406, 407, 408.

Payment processor 401 receives the message 415, validates the data contents, determines the type of message, and processes the authorization request. Payment processor 401 formats a response 416 to message 415 and sends said response message through network 402 to workstation 403. Workstation 403 displays a message to the operator 417 and sends a completion message 410, 412, 414 to any of devices 406, 407, 408.

Peripheral payment devices with communications capability are generally connected to a workstation such as a point of sale (POS) system or personal computer via a USB, RS-232, RS485 or other wired connection. A workstation operator controls the flow of the transaction and hence, operation of the peripheral devices. Additionally, where the payment devices are installed in a self-service system such as a self-checkout, vending or payment kiosk, the peripheral devices are controlled by software in the self-checkout system, vending machine or kiosk and in some embodiments a local server in response to customer actions. Typically, peripheral devices are physically attached to and communicatively part of the local workstation configuration, which sends control commands to and receives data from the peripheral devices. While some devices are capable of running an application, the great majority operate in command/response mode.

Payment system software is responsible for managing transaction flow, which can typically involve several interdependent operations. Further, payment system software is responsible for communicating through a local network and so to a remote server for purposes of validating data and authorizing the transaction. Given that “sensitive data” passes through the payment system, its software and the network, the payment system, software, and network are in scope for security audits.

Payment system software is a popular point of attack for persons trying to acquire sensitive data or damage information systems. When the payment system and network architecture include general-purpose computers, the vulnerabilities of these computers increase the risk and provide attackers ongoing opportunities. Successful attacks have been mounted against such systems.

Where peripheral devices are connected to a local workstation, it is difficult to manage the devices, update their software, forms and other digital assets stored on the devices. It is common for device vendors to use proprietary operating systems, firmware and applications in their devices. This then gives vendors control over the software architecture. Companies, such as retailers that deploy the peripherals cannot maintain the devices on-site. Often the devices must be returned to an authorized repair center or the manufacturer in order to be upgraded. While there are remote device management systems, they require significant changes to the companies' infrastructure and can be costly. Each manufacturer's system is unique. Manufacturers' device management systems are not compatible and may be mutually exclusive. So users of multiple manufacturers' products would have to support two or more systems or select one system leaving some devices unmanaged. Further, if the company changes devices, the new devices may not be compatible with the existing maintenance system. Since device turnover occurs on a 3 to 5 year basis, it is disruptive and costly to the company.

Changes to the payment system software such as operating system patches, may “break” the maintenance system. Application changes intended to meet industry compliance rules are an annual event. Upgrades, feature enhancements, and patches are commonly released on a quarterly schedule. Overall, the burden and cost is so high that the great many of companies decline to use a maintenance system and may forego important software upgrades such as security patches. This makes their payment systems, networks, and devices vulnerable to security weaknesses. There is a need for device maintenance that is vendor agnostic and removes the burden of security and software maintenance. That is, a system that can work with the plurality of different devices from different manufacturers and be remotely managed and upgraded.

Device authentication is also challenging in particular when the devices, workstations and communications means vary across the installed population. There have been several successful attacks in which compromised devices were installed by attackers posing as POS support engineers and subsequently used by unsuspecting consumers. Because workstations generally have no means of ensuring authenticity and integrity or correct operational status for the deployed devices, they cannot determine if the devices are legitimate, up-to-date, or even supposed to be installed. The Payments Security Standards Council has released requirements for all devices to be authenticated and tracked by location. It is not reasonable to manually authenticate many hundreds of devices in dozens of locations. There is a need or remote device authentication and tracking.

Where end user companies maintain their own communications portal for payment transactions, the systems are subject to attack. Several successful security breaches have leveraged retailers' networks as pathways to their payment infrastructure. A typical attack vector finds access to a company server through a poorly secured connection such as used for remote software troubleshooting and maintenance. The access point may be used by outside vendors and/or company personnel. Once in the company's internal network, the attacker finds a path to systems that process sensitive data. Since internal systems are considered trusted, the attacker can use the point of entry to search for data and applications that can be compromised. Thus, it remains challenging for companies to maintain security on their payments infrastructure and networks while enabling access for legitimate purposes.

It should therefore be appreciated that there remains a need for an alternative approach to electronic transactions that addresses these concerns.

### SUMMARY OF THE INVENTION

Briefly, and in general terms, the present invention provides an apparatus and related method for managing of peripheral devices and communication for transmission of sensitive data, such as, payment transactions in a manner that satisfies security concerns while minimizing maintenance of systems that process sensitive data, which can be achieved by reducing or eliminating direct connections from internal networks to workstations and devices, and using a dedicated secure communications link for updates and processing of all sensitive data. In this manner, the system and related method facilitates device maintenance, reduces maintenance overhead and risk of system compromise.

More specifically, in an exemplary embodiment, a device communication management (DCM) apparatus is provided having a first and a second communication ports, a controller, and a non-transitory storage medium containing a set of instructions, to receive an electronic transaction request (such as a payment request) through the first communication port; responsive to the electronic transaction request, format a transaction data capture request; transmit the transaction data capture request through the second communication port; receive transaction data through the second communication port, such that the transaction data is isolated from the first communication port; encrypt a transaction processing request in which the transaction processing request is based on the transaction data; transmit the encrypted transaction processing request through the network communication port; and responsive to a reply to the transaction processing request, transmit a transaction status message through the first communication port.

In a detailed aspect of an exemplary embodiment, the DCM apparatus further comprises a housing that retains the first communication port, the second communication port, the network communication port, the controller, and the non-transitory storage medium.

In another detailed aspect of an exemplary embodiment, the first communication port is in operative communication with a workstation. The second communication port is in operative communication with a peripheral device. The network communication port is in operative communication with a remote server, wherein the set of instructions isolates transaction data from the workstation.

More specifically, in another exemplary embodiment, a method managing device communications includes (a) receiving an update file through the network communication port from the remote server; (b) responsive to the update file, formatting an update message for either a peripheral device or a workstation, in which the first communication port is in operative communication with the workstation and the second communication port is in operative communication with the peripheral device; (c) transmitting the update message to the device through either the first communication port or the second communication, to which the device is connected; (d) receiving an acknowledgement from the device through either the first communication port or the second communication, to which the device is connected; (e) formatting and encrypting a confirmation message; (f) transmitting the encrypted confirmation message through the network communication port to the remote server; and (g) receive an acknowledgement response through the network communication port from the remote server.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 depicts a simplified block diagram of an exemplary system environment in accordance with the present invention.

FIG. 2 depicts a simplified block diagram of another example of a system environment in accordance with the present invention.

FIG. 3 depicts a simplified block diagram of another example of a system environment in accordance with the present invention, including one configuration of apparatus, devices, kiosk with purchaser/payer and server.

FIG. 4 depicts a simplified block diagram of an exemplary system of the prior art.

FIG. 5 depicts a block diagram of an apparatus for device communication management in accordance with the present invention, showing major components therein.

FIG. 6 depicts an example sequence of the apparatus (e.g., 103, 203, 303, 1403) for registration with the server (e.g., 101, 201, 301, 1401) in a system environment in accordance with the present invention, such as FIGS. 1-3.

FIG. 7 depicts an example sequence of the apparatus (e.g., 103, 203, 303, 1403) for device identification (e.g., devices 105-107, 205-207, 305-307, 1405-1407) in a system environment in accordance with the present invention, such as FIGS. 1-3.

FIG. 8 depicts an example sequence of a card present transaction with an attended workstation in a system environment in accordance with the present invention.

FIG. 9 depicts an example sequence of a card present transaction communication sequence with an unattended kiosk in a system environment in accordance with the present invention, such as FIG. 3.

FIG. 10 depicts an example sequence of a card not present transaction with an attended call center workstation in a system environment in accordance with the present invention.

FIG. 11 depicts an example sequence of a card present transaction without a local workstation connection and having local device and remote server control in a system environment in accordance with the present invention.

FIG. 12 depicts an example sequence of a card present transaction without a local workstation connection and having local device control in a system environment in accordance with the present invention.

FIG. 13 depicts an example sequence of a card present transaction without a local workstation connection and having remote server control in a system environment in accordance with the present invention.

FIG. 14 depicts a simplified block diagram of another example of a system environment in accordance with the present invention.

### DETAILED DESCRIPTION OF THE PREFERRED EMBODIMENTS

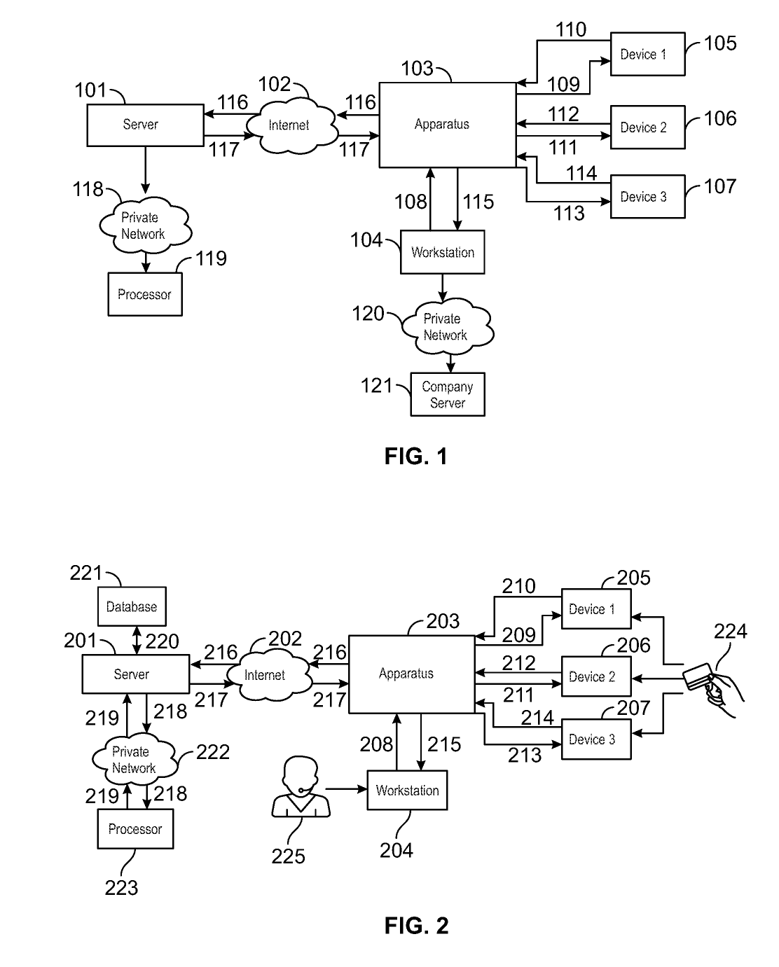

Referring now to the drawings, and particularly FIG. 1, there is shown an exemplary system environment for electronic transactions (such as payment authorizations) in accordance with the present invention. The system includes an apparatus 103 for device communication management installed between peripheral devices 105, 106, 107, and workstation 104. Apparatus further is communicatively connected to the Internet 102, which gives access to a server 101. Workstation 101 is communicatively linked to a private network, which gives access to server 121. Server 101 is communicatively connected to private network 118, which gives access to a transaction processor 119.

The apparatus 103 routes communication among entities based on parameters in said communication, processing state of apparatus 103 and of the sending and receiving entities, and software instructions executing in apparatus 103. Communications such as requests for status can be sent from server 101 through apparatus 103 to any of devices 105, 106, 107, and workstation 104. The response from the queried entity is returned to apparatus 103 and a response to server 101 is formatted and sent. Apparatus 103 may independently communicate such as status query, update request, software update, and parameter update with devices 105, 106, 107, server 101, and workstation 104.

### Exemplary Embodiment of System Environment Having POS Workstation

With reference now to FIG. 2, there is shown another exemplary system environment for electronic payment transactions in accordance with the present invention. The system includes a device communication manager (DCM) apparatus 203, in accordance with the present invention, is installed between peripheral devices 205, 206, 207, workstation 204 and server 201 in order to isolate workstation environment from transaction data, device operation and device management. Apparatus 203 further isolates from transaction data the network to which workstation 204 is connected.

The apparatus 203 communicates through an Internet connection with server 201 and through USB or RS232 connections communicates with workstation 204 and devices 205, 206 and 207. In the example, the Internet connection 202 can be wired or wireless Ethernet or other connection type or protocol. Communication between apparatus 203 and server 201 can be via a private network or other network such as cellular service. Workstation 204 is a computing platform such as a POS terminal, a PC, a tablet, a self-checkout machine, kiosk, or any other computing system. Devices 205, 206, 207 may be a such as multi-function POS device, PIN pad, card reader, signature capture device, printer, check scanner, or other peripheral used in a transaction processing system. Apparatus 203 is configured to execute software comprising an operating system, a plurality of applications, communication port management software, and device drivers.

The workstation 204 sends a request 208 to apparatus 203 to initiate a transaction. The request includes data necessary for software executing in apparatus 203 to initiate the transaction includes such as an amount due, items and/or services identifiers, merchant ID, workstation ID, date and time. On receipt of a valid request, apparatus 203 formats a message 209, 211, or 213 to be sent to a peripheral device 205, 206, or 207. The target device receives the message and performs interactions with a payer 224 to capture additional data. The additional data comprises data such as payment credit card data from payer 224, personal identification number (PIN), electronic signature, acknowledgement of the transaction amount, payer identification data, and responses to marketing queries. The payer 224 may interact with peripheral device 205, 206, or 207 which will capture and store data prior to receipt of a message 209, 211, or 213. Upon completion of the capture of the additional data, the device formats a message 210, 212, 214 to be sent to apparatus 203. The message or data therein may be encrypted. Data specific to the device such as device ID, date, time, and other data needed to manage the device or process the transaction may be included in the message. One or more additional messages may be sent from apparatus 103 to device 205, 206, or 207 to acquire additional data and transmit it to apparatus 103.

On receipt of the device message 210, 212, 214, apparatus 203 parses the message and validates the data, and determines if the transaction can continue. At this time, if there is any reason why the transaction cannot continue, apparatus 203 may respond to workstation 204 with an error condition. Given the transaction can continue, apparatus 203 formats a server message 216. Said message comprises data such as payment data, authentication data, apparatus ID, apparatus firmware revision, and other data necessary for the transaction. The message or portions thereof may be encrypted by apparatus 203 including but not limited to, individual data elements, multiple data elements, and the entire message. Apparatus 203 sends the message 216 to server 201. A protocol such as PCT, SSL or TLS may be used for message security. Upon receipt, server 201 parses the message 216, determines source and type of message, and processes the message to facilitate completion of the transaction. Server 201 may decrypt the message or portions thereof. Processing may include authentication using any of data from the sending apparatus 203, any of devices 205, 206, 207, payer 224 provided data used in the transaction, and of workstation 204.

Server 201 may perform local processing such as querying and/or updating 220 a database 221, verifying identifying data from any of apparatus 203, workstation 204 and/or devices 205, 206, 207, authorization, fraud checking, and other related actions. If server 201 determines there is any reason to prevent the transaction from being further processed, server 201 may respond to apparatus 203 with an error condition message and log the error condition and transaction data to database 221. Additionally server 201 may forward all or a portion of the message 218 to one or more entities such as a payment processor 223 or other third parties via network 222. Processor 223 receives message 218, and takes further action based on the contents of the message 218. Said actions will include such as verifying the message 218 data integrity, verifying sender identity, verifying merchant identity data, executing payment authorization, fraud checking, and database updates. Upon completion of processing the message 218, Processor 223 responds with a result message 219.

Server 201 receives message 219, and processes the message. Server 201 may decrypt all or portions of message 219 prior to processing said message. Server 201 updates database 221 based on the contents of message 219. Server 201 formats a response 217 to apparatus's 203 message 216. The message 217 and portions thereof may be encrypted by server 201 including but not limited to, individual data elements, multiple data elements, and the entire message. Server 201 may add data to the message 219 including but not limited to the transaction processing result, configuration data 519 for any of apparatus 203, workstation 204, or devices 205, 206, 207, and other data needed to complete the transaction. Server 201 sends the response message 217 to apparatus 203.

Upon receipt of message 217, apparatus 203 processes the message and determines the transaction processing result. Apparatus 203 formats a message 215 for workstation 204 and any of the devices 205, 206, 207 and transmits the one or more messages 209, 211, 213, 215. Upon completion of the transaction, apparatus 203 resumes “listening mode” and waits for a message from any of server 201, workstation 204, or devices 205, 206, 207.

### Exemplary Embodiment of Kiosk System Environment

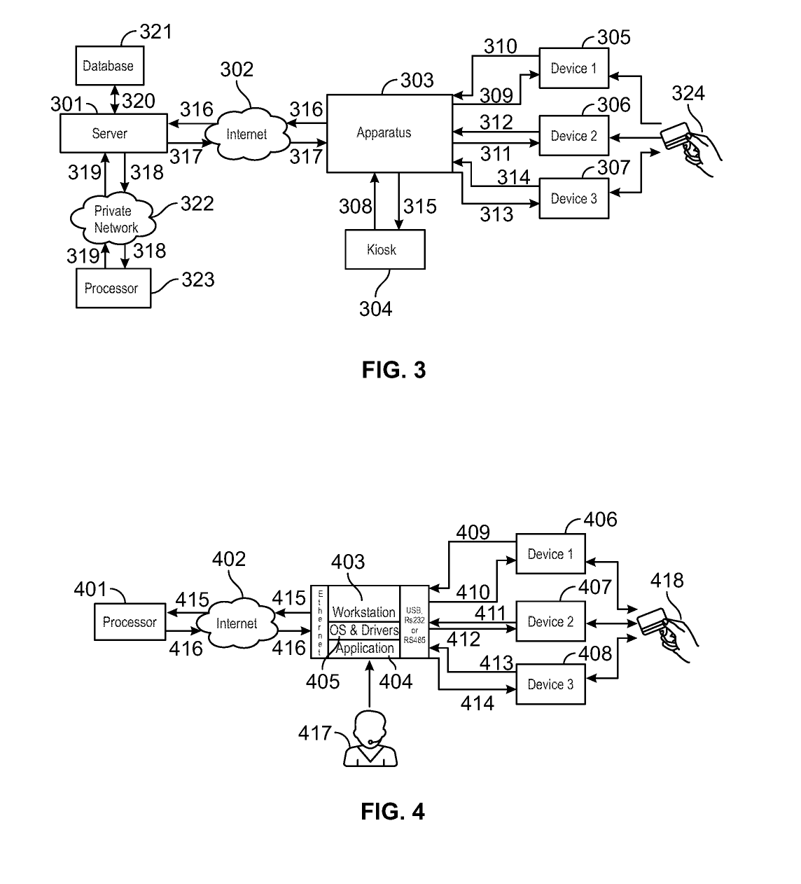

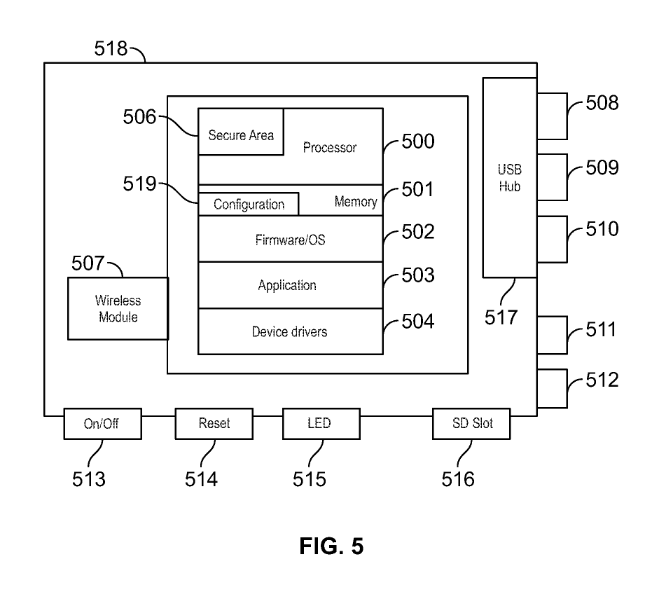

With reference now to FIG. 3, a system environment is shown, depicting an apparatus 303, in accordance with the present invention, installed between peripheral devices 305, 306, 307, a kiosk 304, and a server 301 in order to isolate kiosk environment from transaction data, device operation and device management. The apparatus 303 further isolates the network to which kiosk 304 (aka, unattended workstation) is connected from transaction data.

The apparatus 303 communicates through an Internet connection with server 301 and through such as USB or RS232 connections communicates with kiosk 304 and devices 305, 306 and 307. In the exemplary embodiment, the Internet connection 302 can be wired or wireless Ethernet or other connection type or protocol such as a private or cellular network. The apparatus 303 is in operative communication with kiosk 304.

In the exemplary embodiment, the kiosk 304 is a computing platform such as a POS terminal, PC, special-built computing platform, self-checkout, or any other computing system. Devices 305, 306, 307 may be any such as multi-function POS device, PIN pad, card reader, signature capture device, printer, check scanner, or other peripheral used in a transaction processing system. Apparatus 303 is configured to execute software comprising an operating system, a plurality of applications, communication port management software, and device drivers.

With continued reference to FIG. 3, a payer 324 interacts with kiosk 304 to select items and/or services to purchase. Kiosk 304 sends a request 308 to apparatus 303 to initiate a payment transaction based on payer's 324 selection. The request includes data necessary for software executing in apparatus 303 to initiate the transaction and includes such as an amount due, items and/or services identifiers, merchant ID, kiosk ID, payer ID, date and time. On receipt of a valid request, apparatus 303 formats a message 309, 311, or 313 to be sent to peripheral device 305, 306, or 307. The target device receives the message and performs interactions with a payer 324 to capture additional data. The additional data comprises data such as payment credit card data, personal identification number (PIN), electronic signature, acknowledgement of the transaction amount, and payer's 324 responses to marketing or other queries. The payer 324 may interact with peripheral device 305, 306, or 307 which will capture and store data prior to receipt of a message 309, 311, or 313. Upon completion of the capture of the additional data, the device 305, 306, or 307 formats a message 310, 312, 314 to be sent to apparatus 303. The message or data therein may be encrypted. Data specific to the device such as device ID, date, time, and other data needed to manage the device or process the transaction may be included in the message.

On receipt of the device message 310, 312, 314, apparatus 303 parses the message and validates the data, and determines if the transaction can continue. At this time, if there is any reason why the transaction cannot continue, apparatus 303 may respond to kiosk 304 with an error condition and log the error condition and transaction data to database 321. Given the transaction can continue, apparatus 303 formats a server message 316. Said message comprises payment data, authentication data, apparatus ID, apparatus firmware revision, and other data necessary for the transaction. The message or portions thereof may be encrypted by apparatus 303 including but not limited to, individual data elements, multiple data elements, and the entire message. Apparatus 303 sends the message 316 to server 301. A protocol such as PCT, SSL or TLS may be used for message security. Upon receipt, server 301 parses the message 316, determines source and type of message, and processes the message to facilitate completion of the transaction. Server 301 may decrypt the message or portions thereof. Processing may include authentication of any of data from the sending apparatus 303, any of devices 305, 306, 307 used in the transaction, and kiosk 304.

Server 301 may perform local processing such as querying and/or updating a database 321, verifying identifying data from any of apparatus 303 kiosk 301 and/or devices 305, 306, 307, authorization, fraud checking, and other related actions. If server 301 determines there is any reason to prevent the transaction from being further processed, server 301 may respond to apparatus 303 with an error condition message. Additionally server 301 may forward all or a portion of the message 318 to one or more entities such as a payment processor 323 or other third parties via network 322. Processor 323 receives message 318, and takes further action based on the contents of the message 318. Said actions will include such as verifying the message 318 data integrity, verifying sender identity, verifying merchant identity data, executing payment authorization, fraud checking, and database updates. Upon completion of processing the message 318, Processor 323 responds with a result message 319.

Server 301 receives message 319, and processes the message. Server 301 may decrypt all or portions of message 319 prior to processing said message. Server 301 updates database 321 based on the contents of message 319. Server 301 formats a response 317 to apparatus's 303 message 316. The message 317 and portions thereof may be encrypted by server 301 including but not limited to, individual data elements, multiple data elements, and the entire message. Server 301 may add data to the message 319 including but not limited to the transaction processing result, configuration data 519 for any of apparatus 303, kiosk 304, or devices 305, 306, 307, and other data needed to complete the transaction. Server 301 sends the response message 317 to apparatus 303.

Upon receipt of message 317, apparatus 303 processes the message and determines the transaction processing result. Apparatus formats a message 315 for kiosk 304 and any of the devices 305, 306, 307 and transmits the one or more messages 309, 311, 313, 315. Upon completion of the transaction, apparatus 303 resumes “listening mode” and waits for a message from any of server 301, kiosk 304, or devices 305, 306, 307.

### Exemplary Apparatus Design

With reference now to FIG. 5, an exemplary embodiment of an apparatus (e.g., 103, 203, 303), in accordance with the present invention, usable with the system environments depicted in FIGS. 1-3, among others. For example, FIG. 2 depicts a system environment in which apparatus 203 is used in a transactional environment such as those that accept credit card payments. Apparatus 103, 203, 303 comprises a housing 518 which encloses a processor 500 (e.g., controller) with a secure area 506, memory 501 (e.g., non-transitory storage medium), USB ports 508, 509, 510, RS232 port 511, and Ethernet port 512, wireless communication module 507, on/off switch 513, reset switch 514, LED 515, SD Card slot 516, USB Hub 517. The processor 500 (e.g., controller) is configured to execute an operating system and/or firmware 502, a plurality of applications 503 and device drivers 504. Secure area 506 stores sensitive data and firmware such as encryption keys, executable encryption algorithm code, and configuration data 519.

Input and output of data and messages via USB ports 508, 509, 510, RS232 port 511, Ethernet port 512, and wireless communication module 507 are controlled by a controller, e.g., software executing on processor 500. Protocols, communication speed and other configurable elements are selected based on the capabilities of the attached devices, the protocols and device drivers available to the OS and firmware 502, and capabilities of the application(s) 503. Communication to or from any port is processed by the processor 500 (e.g., controller) and the logic executing in Firmware/OS 502 and/or applications 503.

Messages, software executables, configuration data 519, operational status, logs, and other information may be temporarily stored in memory 501 or alternatively on an optional SD card inserted in slot 516. In some embodiments, additional memory in the SD card form factor may be desirable to hold files or updates to the applications 503 or Firmware/OS 502. In other embodiments, the files may be intended for an external device 205, 206, 207, kiosk 304, or workstation 204. Upon receipt, the files could be temporarily stored in memory 501, or on the SD card in slot 516. Temporary storage would enable the applications 503 to authenticate such files, check for errors introduced by communication failure, buffer the file for later transmission to the target entity, reformat the file and reconfigure the file in a different protocol. Pressing the On/Off switch 513 powers up and powers off apparatus 203. In an exemplary embodiment, the reset switch 514 causes the apparatus to return to a known, stable state. For example, if the application has been corrupted pressing the reset switch 514 would cause apparatus to erase the application and return to a “factory state.” The Firmware/OS 503 would then communicate with server 201 and request a new file. Server 201 would respond to the request and send the appropriate file to reinstate the operational mode of apparatus 203. The LED 515 shows status of apparatus 203 and can indicate several operational states. Among the operational states are powered off, operating normally, error condition, registering, authenticating, installing, and idle state. In other embodiments, the LED 215 could be used to diagnose error conditions by flashing colors and/or sequences and/or durations that can be mapped to documentation.

With continued reference to FIG. 5, processor 500 (e.g., controller) may support features such as data and code authenticity and integrity, cryptographic acceleration and anti-tamper protections. Processor 500 and secure area 506 monitor the security of apparatus 203, authenticity of executable code, configuration, and message authenticity and integrity. Security monitoring may include anti-tamper mechanisms such as detecting physical penetration, housing breach, temperature variation, power variation, and software attacks. In the event that a security violation is detected, the processor 500 could initiate self-protective action such as erasing sensitive data and applications. Erasure would render apparatus 203 unusable. Reinstating apparatus 203 to an operational state following erasure would be performed only by an authorized entity employing strong security measures.

### Exemplary Method for Apparatus Registration

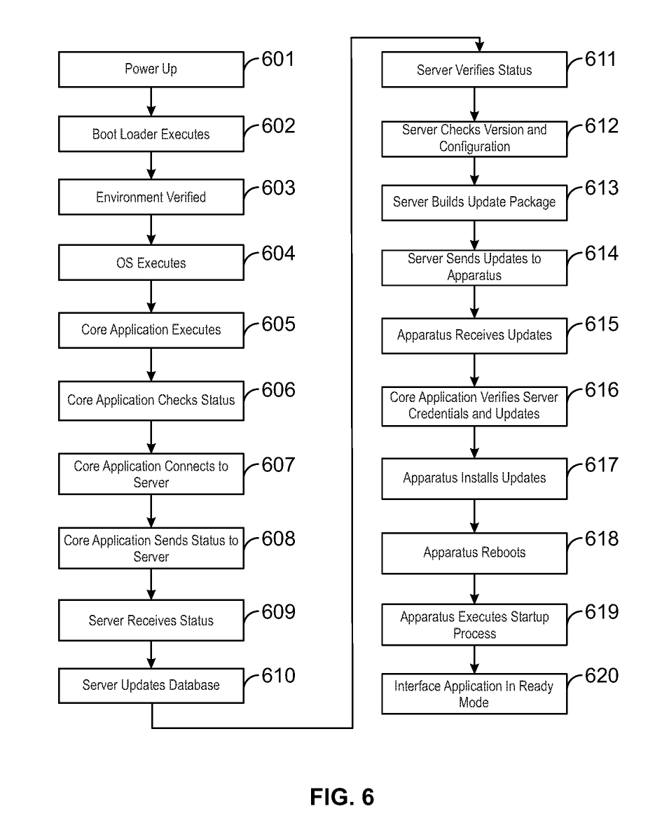

With reference now to FIG. 6, an exemplary flowchart is provided, depicting the process flow for registering the apparatus (e.g., 103, 203, 303) with the server (e.g., 101, 201, 301) in a system environment in accordance with the present invention, such as FIGS. 1-3. More particularly, the steps enable the apparatus to register with server validate workstation application and devices. Error conditions can result in the Apparatus unit being marked down with an alert status.

The process can initiate at step 601, in which the apparatus powers up and executes its boot up software. In the exemplary embodiment, the steps are performed as follows:

| Step | Task |
|---|---|
| 601. | Apparatus (103) powers up and executes its boot up software (502) |
| 602. | Boot Loader (502) executes from secure memory |
| 603. | Boot Loader (502) and security firmware (502) validate hardware and software |
| 604. | Operating (502) system executes and the Core Application (503) starts |
| 605. | Core Application (503) Executes and begins system status checks |
| 606. | Core Application (503) checks system status and gathers data |
| 607. | Ethernet communication (504) startup and Core Application (503) connects to Server |
| | (101) |
| 608. | Core Application (503) sends an initialization message with its credentials and system |
| | status to server (101) |
| 609. | Server (101) receives initialization message |
| 610. | Server (101) updates device management database (221) using data received from the |
| | Core Application (503) |
| 611. | Server validates Apparatus status and builds an authentication response |
| 612. | Server (101) checks Apparatus (103) software versions and configuration data (519) |
| 613. | Server (101) builds response to Apparatus (103) including any updates needed to OS |
| | (502), Applications (503), configuration files (519), security data |
| 614. | Server (101) sends response to Apparatus (103) |
| 615. | Apparatus Core Application (503) receives server (101) response |
| 616. | Core Application (503) validates server (101) credentials and the updates received |
| | a. If successful, Apparatus (103) ACKs server (101) and server and Apparatus unit are |
| | mutually authenticated |
| 617. | Core Application (503) installs Apparatus (103) updates as needed |
| 618. | Apparatus (103) completes updates and reboots |
| 619. | Apparatus (103) executes boot process, starts OS (502) and Core Application (503). |
| | Core Application executes Interface Application (503) |
| 620. | Interface Application (503) is in Ready Mode |

The above-mentioned steps are provided as exemplary. Steps can be eliminated, combined, or added without departing from the invention. Moreover, in certain embodiments, steps can be performed in a different order without departing from the invention.

### Exemplary Method for Device Identification

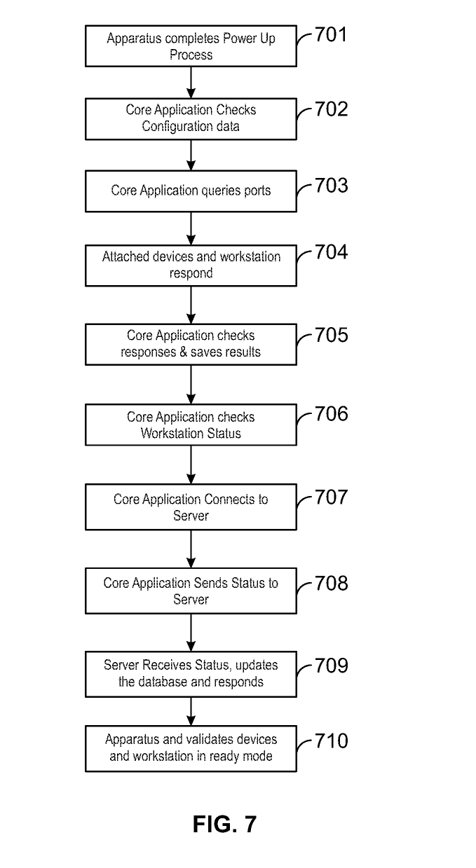

With reference now to FIG. 7, an exemplary flowchart is provided, depicting an exemplary sequence of the apparatus (e.g., 103, 203, 303) for device identification (e.g., devices 105-107, 205-207, 305-307) in a system environment in accordance with the present invention, such as FIGS. 1-3. In the exemplary embodiment, the steps are performed as follows:

| Step | Task |
|---|---|
| 701. | Apparatus (103) completes Boot Up and Registration Process including any updates |
| | from the Server.101) |
| 702. | Core Application (503) reads configuration file (519) to determine expected devices |
| | (105, 106, 107) and workstation (104) connections. |
| 703. | Apparatus Core Application (503) queries devices (ports 508, 509, 510, 511) to |
| | identify the attached devices based on server (101) supplied device configuration data |
| | (519) stored in Apparatus (103) memory (501) |
| 704. | Devices (105, 106, 107) (respond with serial number, and other data such as firmware |
| | revision. |
| 705. | Apparatus (103) validates device (105, 106, 107) responses (110, 112, 114) and logs |
| | results to memory (501) |
| | a. Any port (508, 509, 510, 511) that times out, Core Application (503) flags as |
| | unresponsive |
| 706. | Apparatus (103) validates workstation (104) application and logs results to memory |
| | (501) |
| | a. Apparatus (103) and workstation (104) are mutually authenticated |
| 707. | Core Application (503) connects to Server.(101) |
| 708. | Apparatus (103) builds server (101) message including workstation (104) and device |
| | (105, 106, 107) data and sends to server (101) |
| 709. | Server (101) receives Apparatus (103) message, updates the database (221) with |
| | workstation and device data and responds to Apparatus (103). |
| | a. Server (101) application checks the database (221) for Workstation (103) and |
| | Device (105, 106, 107) software for update. Device (105, 106, 107) forms and |
| | applications are also checked for possible update. If needed, the update(s) can be |
| | pushed to Devices (105, 106, 107) via Apparatus (103) or scheduled for another |
| | time. It is likely that updates will not be done during the clients' business hours |
| | unless they are necessary for operation. |
| 710. | Apparatus (103) is now ready to process |

The above assumes no errors occur. The user will see the status LED cycle from off to solid green. If an error occurs, the status LED will indicate the first error condition it encounters. Setup will halt at that error. If mutual authentication with workstation, kiosk, or any of devices fails in any part, apparatus NAKs the other entity and notifies server of the error condition. If server mutual authentication fails in any part, server or apparatus will NAK. Any failure will cause apparatus unit to be marked in alert state in the server database.

The above-mentioned steps are provided as exemplary. Steps can be eliminated, combined, or added without departing from the invention. Moreover, in certain embodiments, steps can be performed in a different order without departing from the invention.

Exemplary Method for Workstation Card Present Flow with Operator

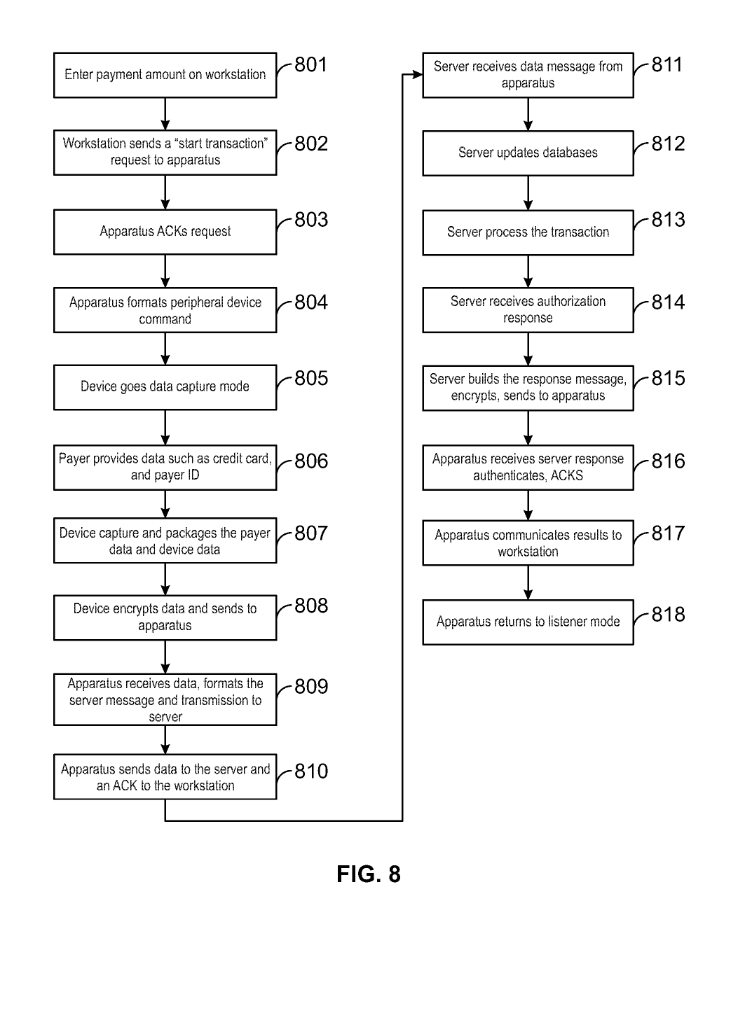

With reference now to FIG. 8, an exemplary flowchart is provided, for an example sequence of a card present transaction with an attended workstation in a system environment in accordance with the present invention. the exemplary embodiment, the steps are performed as follows:

| Step | Task |
|---|---|
| 801. | Operator (225) enters the amount of the payment and any other non-sensitive data on |
| | workstation (204). Alternatively, the client systems may auto-fill the data. A |
| | payment transaction is initiated by operator (225) on the local workstation (203) |
| | (click the [Pay Now] button) |
| 802. | Workstation (203) application (503) (may be an executable program or a browser |
| | page) sends a “start payment transaction request” (to apparatus. Data may include the |
| | payment amount, items and/or services identifiers, merchant ID, etc. The message |
| | may include the ID of the device to be used for payer's (224) payment data entry or |
| | the current default port may be used. |
| 803. | Apparatus (203) ACKs (215) the request |
| 804. | Apparatus (203) application (503) formats the first device command and sends the |
| | message (209, 211, 213) to the device (205, 206, 207). |
| 805. | The device (205, 206, 207) enters encrypting data capture mode and captures payer |
| | (224) data such as credit card number, expiry date, and CVV. Other data may be |
| | requested for address verification. (Device may be preconfigured for the data entry |
| | sequence or respond to commands from the apparatus.) |
| 806. | The payer (224) provides payment card information with swipe, card insert, card tap, |
| | and keypad entry as needed. |
| 807. | Device (205, 206, 207) packages the payer (224) data and device data and formats it |
| | for transmission to apparatus. |
| 808. | Device (205, 206, 207) encrypts the data and sends it to apparatus (203). |
| 809. | Apparatus (203) receives the payer (224) data from device (205, 206, 207), combines |
| | it with workstation (204) data and apparatus (203) data to build a server (201) |
| | message. Apparatus (203) formats the header and trailer, adds authentication data. |
| 810. | Apparatus (203) sends transaction message (216) to the server (201) and a status |
| | message to workstation (204) application. Workstation (204) application may display |
| | the status for the operator (225). |
| 811. | Server (201) receives the payment data package (216), authenticates it and extracts |
| | the payload. |
| 812. | Server (201) updates the transaction and device databases (221) (Transaction |
| | date/time, device ID, merchant ID, items and/or services identifiers, etc. No sensitive |
| | data retained) |
| 813. | Server (201) processes the payment transaction (216) (e.g. an authorization)—sends |
| | the authorization request (218) to the payment network (222). |
| 814. | Server (201) receives the authorization response (219). |
| 815. | Server (201) builds the message and sends the authorization results (217) to |
| | Apparatus (203). |
| 816. | Apparatus (203) gets the response (217) from server (201), authenticates, extracts |
| | payload, ASKS server (201) |
| 817. | Apparatus (203) sends transaction result message (215) to workstation (204) |
| | application (Status of transaction, authorization code, etc. May include an error code |
| | if the transaction failed to authorize.) |
| 818. | Apparatus (203) sends completion message to device(s) (205, 206, 207) and returns to |
| | listener mode. |

The above-mentioned steps are provided as exemplary. Steps can be eliminated, combined, or added without departing from the invention. Moreover, in certain embodiments, steps can be performed in a different order without departing from the invention.

### Exemplary Method for Kiosk Card Present Flow

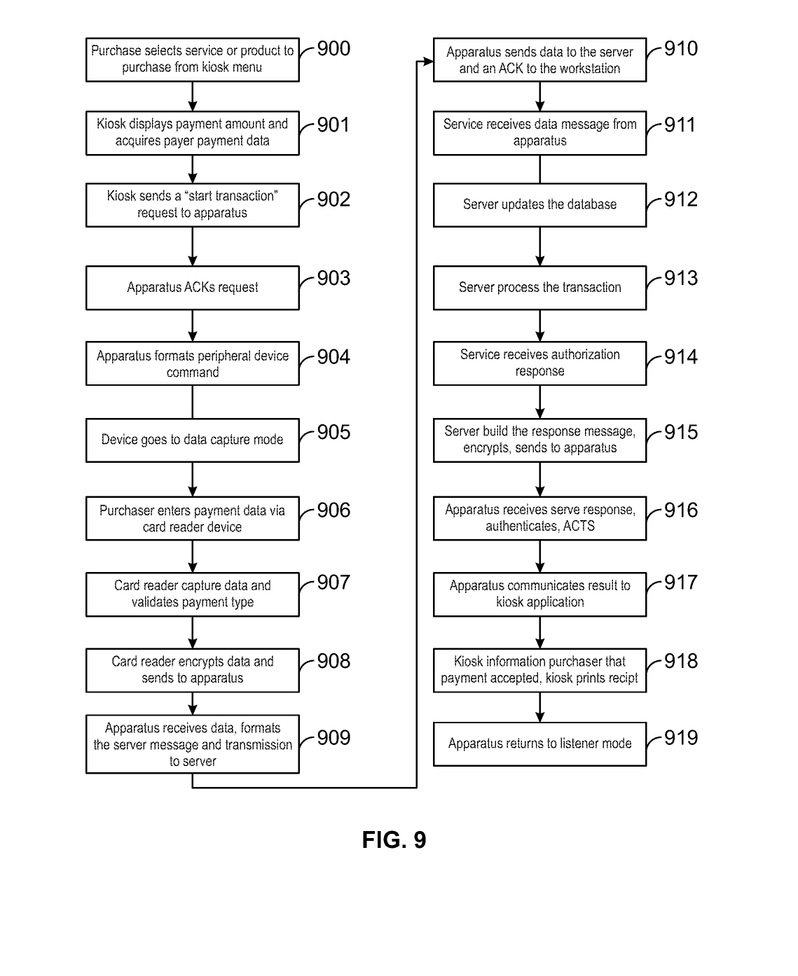

With reference now to FIG. 9, an exemplary flowchart is provided, for an example sequence of a card present transaction communication sequence with an unattended kiosk in a system environment in accordance with the present invention, such as FIG. 3. In the exemplary embodiment, the steps are performed as follows:

| Step | Task |
|---|---|
| 900. | Payer (324) selects services or products depicted or listed on a display or other |
| | selection mechanism such as entering an item code on a keypad or using a touch |
| | screen on kiosk (304). |
| 901. | Kiosk (304) application informs payer (324) of the total amount of the transaction. |
| | Payer (324) provides electronic payment data such as a credit card swipe. |
| 902. | Kiosk (304) application (may be an executable program or a browser page) sends a |
| | “start payment request” (308) to apparatus (303). Data may include the payment |
| | amount, merchant ID, payer (324) data, and other transaction data. The message may |
| | include the ID of the device (305, 306, 307) used for payer's (324) payment data |
| | entry or the current default port may be used. |
| 903. | Apparatus (303) ACKs (315) the request (308) |
| 904. | Apparatus (303) application formats the first device command and sends the message |
| | (309, 311, 313) to the data capture device (305, 306, 307). |
| 905. | The device (305, 306, 307) enters encrypting entry mode. Kiosk (304) instructs the |
| | payer (324) to perform the payment data capture event such as inserting a credit card. |
| 906. | The payer (324) provides payment card information. |
| 907. | The device (305, 306, 307) captures and validates the payer's (324) payment data. |
| 908. | The device (305, 306, 307) encrypts the data in whole or in part and sends (310, 312, |
| | 314) it to apparatus (303). |
| 909. | Apparatus (303) receives the device data message, formats a server (301) message |
| | including such as a header and trailer, authentication data, payment data, items and/or |
| | services identifiers, kiosk ID, merchant ID, apparatus ID, date and time. |
| 910. | Apparatus (303) sends the message (316) to server (301) and a status message (315) |
| | to kiosk (304) application. Kiosk (304) application may display the status for the |
| | payer (324). |
| 911. | Server (301) receives the payment data package, authenticates it and extracts the |
| | payload. |
| 912. | Server (301) updates the transaction and device databases (321) (Transaction |
| | date/time, etc. No sensitive data is retained.) |
| 913. | Server (301) processes the payment transaction (e.g. an authorization)—sends the |
| | authorization request (318) to the payment network (322). |
| 914. | Server (301) receives the authorization response.(319) |
| 915. | Server (301) builds the authorization results message (317) and sends it to |
| | apparatus.(303) |
| 916. | Apparatus (303) gets the response (317) from server, authenticates, extracts payload, |
| | ACKS server (301). |
| 917. | Apparatus (303) sends transaction result message data (315) such as status of |
| | transaction, authorization code to kiosk (304) application. |
| 918. | Kiosk (304) informs payer (324) of the results of the authorization such as approved |
| | or declined. Kiosk (304) prints a receipt. |
| 919. | Apparatus (303) returns to listener mode waiting for the next message from kiosk |
| | (304) or server.(301) |

The above-mentioned steps are provided as exemplary. Steps can be eliminated, combined, or added without departing from the invention. Moreover, in certain embodiments, steps can be performed in a different order without departing from the invention.

### Exemplary Method for “Card not Present” Transaction

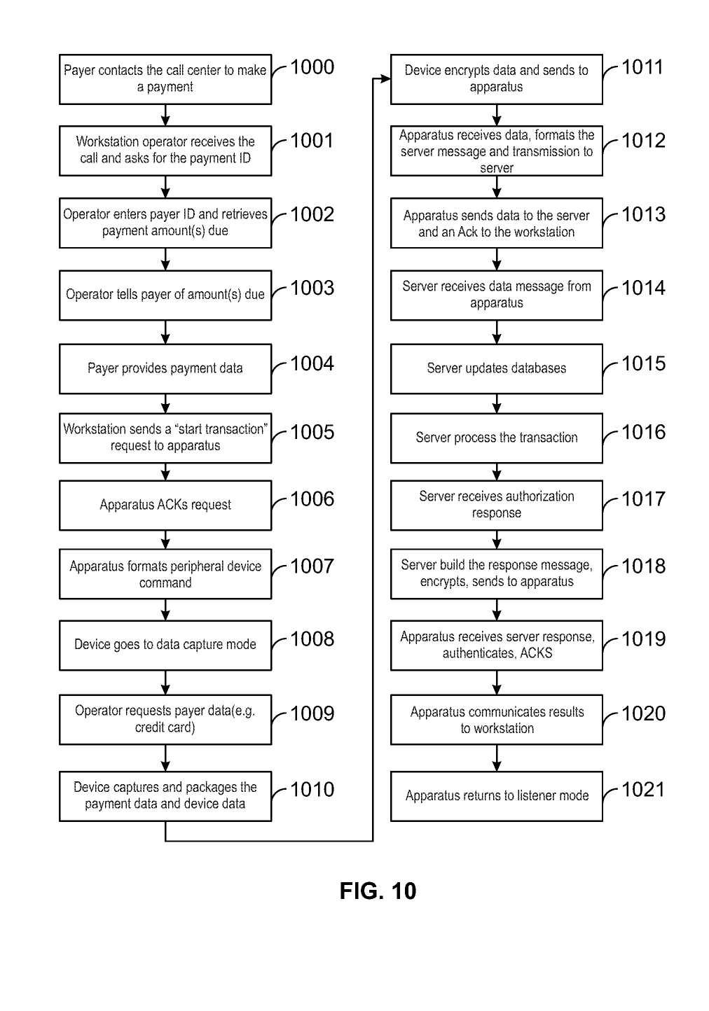

With reference now to FIG. 10, an exemplary flowchart is provided, for an example sequence of a “card not present” transaction with an attended call center workstation in a system environment in accordance with the present invention. In the exemplary embodiment, the steps are performed as follows:

| Step | Task |
|---|---|
| 1000. | Payer (224) contacts call center to perform a payment. |
| 1001. | Workstation operator (225) takes call and asks for payer (224) ID information. |
| 1002. | Operator (225) enters payer data and retrieves amount due for services and/or |
| | products. Operator (225) and payer (324) interact to determine which services and/or |
| | products the payer (224) will pay for. |
| 1003. | Operator (225) informs payer (224) of the total amount of the transaction, receives a |
| | verbal confirmation and initiates the payment transaction on the workstation. |
| 1004. | Payer (224) provides electronic payment data such as a credit card primary account |
| | number, name on the card, card type, expiration date, and security code. |
| 1005. | Workstation (204) application (may be an executable program or a browser page) |
| | sends a “start payment request” (208) to apparatus (203). The request may include |
| | amount, items and/or services identifiers, merchant ID, and other data needed to |
| | process the transaction. |
| 1006. | Apparatus (203) ACKs (215) the workstation (204) request (208) |
| 1007. | Apparatus (203) application formats the first device (205, 206, 207) command and |
| | sends the message (209, 211, 213) to the secure keypad device (205, 206, 207). |
| | Additional commands may be used based on the transaction requirements and device |
| | (205, 206, 207) configuration. |
| 1008. | The device (205, 206, 207) enters encrypting key entry mode to capture payment data |
| | such as credit card number, expiry date, and CVV. Other data may be requested for |
| | address verification and other purposes. (Device (205, 206, 207) may be |
| | preconfigured for the data entry sequence or data capture may be controlled by |
| | apparatus.) |
| 1009. | The operator (225) requests the payer's (224) payment card information and enters it |
| | on the secure keypad (205, 206, 207). Data includes the payment amount, items |
| | and/or services identifiers, merchant ID, payer (224) data, and other transaction data. |
| | The message may include the ID of the device used for payer's (224) payment data |
| | entry. |
| 1010. | Operator (225) enters payer (224) data on the secure keypad device (205, 206, 207). |
| 1011. | Device formats the data, encrypts it, and sends it to apparatus in one or more |
| | messages. |
| 1012. | Apparatus (203) receives the secure keypad messages (210, 212, 214) and builds a |
| | server (201) transaction. Apparatus formats the header and trailer, adds |
| | authentication data, and encrypts the data. |
| 1013. | Apparatus (203) sends the transaction message (216) to server (201) and a status |
| | message (215) to the workstation (204) application. Workstation (204) application |
| | displays the status for the operator (225). |
| 1014. | Server (201) receives the payment data message (216), authenticates it and extracts |
| | data. |
| 1015. | Server (201) updates the device and transaction databases (221) (Transaction |
| | date/time, etc. No sensitive data retained) |
| 1016. | Server (201) processes the payment transaction (e.g. an authorization)—sends the |
| | authorization request (218) to the payment network (222). |
| 1017. | Server (201) receives the authorization response (219) from payment network (222). |
| 1018. | Server (201) builds the authorization results message (217) and sends it to apparatus |
| | (203). |
| 1019. | Apparatus (203) gets the response (219) from server (201), authenticates, extracts |
| | payload, ACKS (216) server (201). |
| 1020. | Apparatus (203) sends transaction result message (215) data such as status of |
| | transaction, authorization code to kiosk (204) application. |
| 1021. | Apparatus returns to listener mode waiting for the next message from kiosk or server. |

The above-mentioned steps are provided as exemplary. Steps can be eliminated, combined, or added without departing from the invention. Moreover, in certain embodiments, steps can be performed in a different order without departing from the invention.

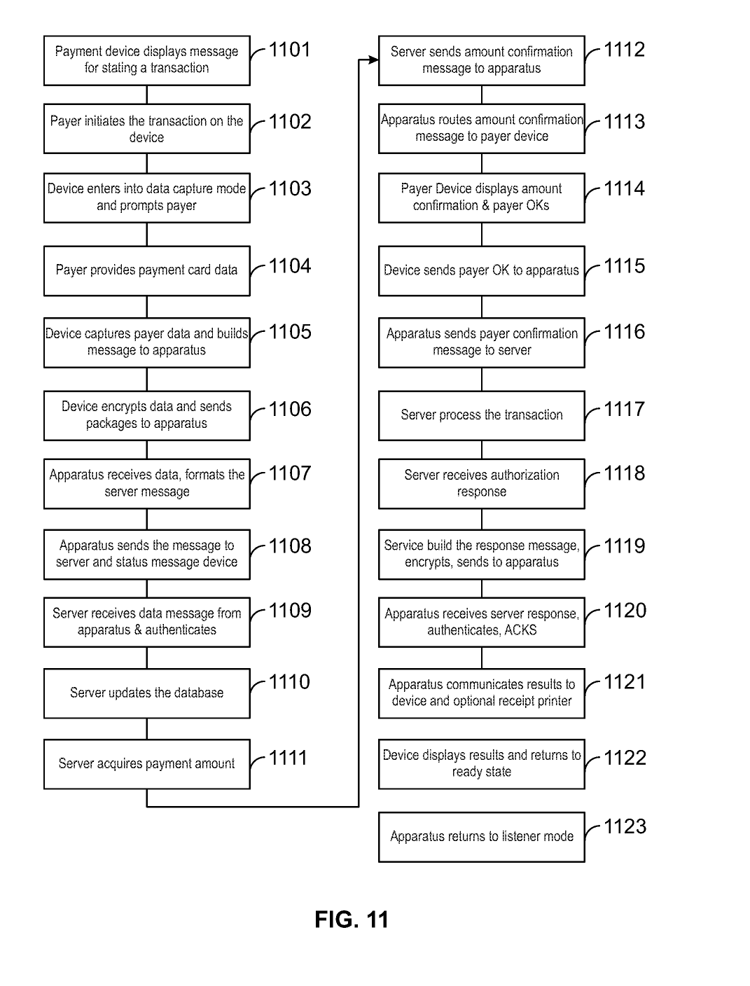

With reference now to FIG. 11, an exemplary flowchart is provided, for an example sequence of a card present transaction communication sequence with a device in a system environment in accordance with the present invention, such as FIG. 3. In the exemplary embodiment, the steps are performed as follows:

| Step | Task |
|---|---|
| 1101. | Payment device (1405, 1406, 1407) displays a message that informs the payer (1424) |
| | to insert, wave or swipe their payment card, press a button or otherwise indicate the |
| | start of a transaction. |
| 1102. | Payer (1424) starts the transaction by interacting with device (1405, 1406, 1407). |
| 1103. | Device (1405, 1406, 1407) enters encrypting entry mode. Device (1405, 1406, 1407) |
| | instructs the payer (1424) to perform the payment data capture event such as inserting |
| | a credit card. |
| 1104. | Payer (1424) provides payment card information and other data as needed. |
| 1105. | Device (1405, 1406, 1407) captures and validates payer's (1424) payment data. |
| 1106. | Device (1405, 1406, 1407) encrypts payer's (1424) captured data, formats a message |
| | to apparatus (1403) and sends the message (1410, 1412, 1414) to apparatus. |
| 1107. | Apparatus (1403) receives device (1405, 1406, 1407) message, parses the data, |
| | validates the message and formats a message for server (1401). |
| 1108. | Apparatus (1403) sends message (1416) to server (1401) and a status message (1409, |
| | 1411, 1413) to device (1405, 1406, 1407). The server (1401) message (1417) may |
| | include the ID of the device (1405, 1406, 1407) used for capturing payer's (1424) |
| | data entry or the current default port may be used. Device (1405, 1406, 1407) may |
| | display the status for the payer (1424). |
| 1109. | Server (1401) receives the payment data package, authenticates it and extracts the |
| | payload. |
| 1110. | Server (1401) updates the transaction and device databases (1421) (Transaction |
| | date/time, etc. No sensitive data is retained.) |
| 1111. | Server (1401) acquires the transaction payment amount based on the data sent from |
| | apparatus (1403). |
| 1112. | Server (1401) formats a response message (1417) including the transaction payment |
| | amount and other data needed to complete the transaction and sends message (1417) |
| | to apparatus (1403). |
| 1113. | Apparatus (1403) receives server (1401) message (1417), parses the message, |
| | validates the payload, formats a confirmation request message (1409, 1411, 1413) and |
| | sends it to device (1405, 1406, 1407). |
| 1114. | Device (1405, 1406, 1407) displays the confirmation message including amount of |
| | the transaction. Payer interacts with device (1405, 1406, 1407) to accept the |
| | transaction. |
| 1115. | Device (1405, 1406, 1407) formats a response (1410, 1412, 1414) confirming payer |
| | (1424) acceptance and sends it to apparatus (1403). |
| 1116. | Apparatus (1403) receives the device (1405, 1406, 1407) confirmation message |
| | (1410, 1412, 1414), formats a transaction message (1416) including apparatus (1403) |
| | and device (1405, 1406, 1407) identification information and sends it to server |
| | (1401). |
| 1117. | Server (1401) processes the payment transaction (e.g. an authorization)—sends the |
| | authorization request (1418) to the payment network (1422). |
| 1118. | Server (1401) receives the authorization response (1419). |
| 1119. | Server (1401) builds the authorization results message (1417) and sends it to |
| | apparatus.(1403) |
| 1120. | Apparatus (1403) receives the response (1417) from server (1401), authenticates, |
| | extracts payload, and ACKS (1416) server (1401). |
| 1121. | Apparatus (1403) sends transaction result message (1409, 1411, 1413) including data |
| | such as status of transaction and authorization code to device (1405, 1406, 1407). |
| 1122. | Device (1405, 1406, 1407) informs payer (1424) of the results of the authorization |
| | such as approved or declined. |
| 1123. | Apparatus (1403) returns to listener mode waiting for the next message (1410, 1412, |
| | 1414) from device (1405, 1406, 1407) or message (1417) server (1401). |

The above-mentioned steps are provided as exemplary. Steps can be eliminated, combined, or added without departing from the invention. Moreover, in certain embodiments, steps can be performed in a different order without departing from the invention.

### Exemplary Method for No Workstation and Local Control Flow

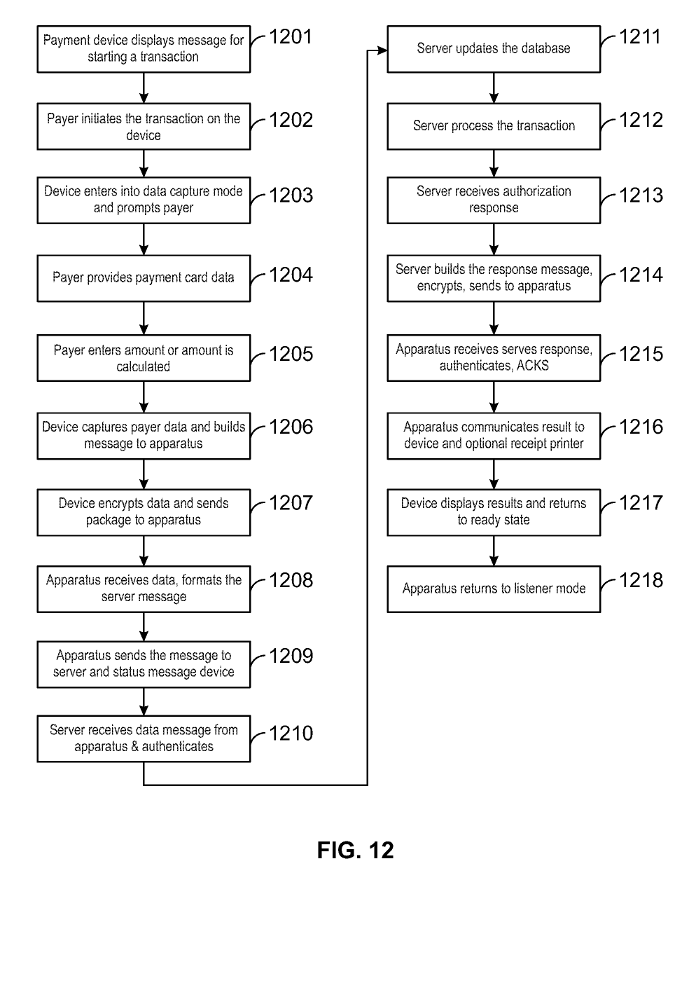

With reference now to FIG. 12, an exemplary flowchart is provided, for an example sequence of a card present transaction communication sequence with a device in a system environment in accordance with the present invention, such as FIG. 3. In the exemplary embodiment, the steps are performed as follows:

| Step | Task |
|---|---|
| 1201. | Payment device displays a message that informs the Payer (1424) to insert, wave or |
| | swipe their payment card, press a button or otherwise indicate the start of a |
| | transaction. |
| 1202. | Payer (1424) starts the transaction by interacting with the device (1405, 1406, 1407). |
| 1203. | Device (1405, 1406, 1407) enters encrypting entry mode. Device (1405, 1406, 1407) |
| | instructs the payer (1424) to perform the payment data capture event such as inserting |
| | a credit card. |
| 1204. | Payer (1424) provides payment card information and other data as needed. |
| 1205. | Payer (1424) provides payment amount or device (1405, 1406, 1407) calculates |
| | amount of the transaction. Amount calculation may be based on data such as location |
| | and time of day or data captured by device (1405, 1406, 1407) such as scanning a bar |
| | code. |
| 1206. | Device (1405, 1406, 1407) formats a message to apparatus (1403) including data such |
| | as amount, date and time stamp, location, and device (1405, 1406, 1407) identifying |
| | data. |
| 1207. | Device (1405, 1406, 1407) encrypts payer's (1424) captured data and other data and |
| | sends message (1410, 1412, 1414) to apparatus (1403). |
| 1208. | Apparatus (1403) receives device (1405, 1406, 1407) message (1410, 1412, 1414), |
| | parses the data, validates the data and message and formats a message for server |
| | (1401). |
| 1209. | Apparatus (1403) sends the message (1416) to server (1401) and a status message |
| | (1409, 1411, 1413) to device (1405, 1406, 1407). The server (1401) message may |
| | include device (1405, 1406, 1407) identification data such as the serial number of |
| | device (1405, 1406, 1407) used for capturing payer's (1424) data entry or the current |
| | default port (508, 509, 510, 511, 512). Device (1405, 1406, 1407) may display a |
| | status for the payer (1424). |
| 1210. | Server (1401) receives the payment data package, authenticates it and extracts the |
| | payload. |
| 1211. | Server (1401) updates the transaction and device databases (1421) (Transaction |
| | date/time, etc. No sensitive data is retained.) |
| 1212. | Server (1401) processes the payment transaction (e.g. an authorization)—sends the |
| | authorization request (1418) to the payment network (1422). |
| 1213. | Server (1401) receives the authorization response (1419). |
| 1214. | Server (1401) builds the authorization results message (1417) and sends it to |
| | apparatus.(1403) |
| 1215. | Apparatus (1403) receives the response (1417) from server (1401), authenticates, |
| | extracts payload, and ACKS (1416) server (1401). |
| 1216. | Apparatus (1403) sends transaction result message (1410, 1412, 1414) including data |
| | such as status of transaction and authorization code to device (1405, 1406, 1407). |
| 1217. | Device (1405, 1406, 1407) informs payer (1424) of the results of the authorization |
| | such as approved or declined. |
| 1218. | Apparatus (1403) returns to listener mode waiting for the next message (1410, 1412, |
| | 1414) from device (1405, 1406, 1407) or message (1417) server (1401). |

The above-mentioned steps are provided as exemplary. Steps can be eliminated, combined, or added without departing from the invention. Moreover, in certain embodiments, steps can be performed in a different order without departing from the invention.

Exemplary Method for No Workstation with Remote Server Control Flow

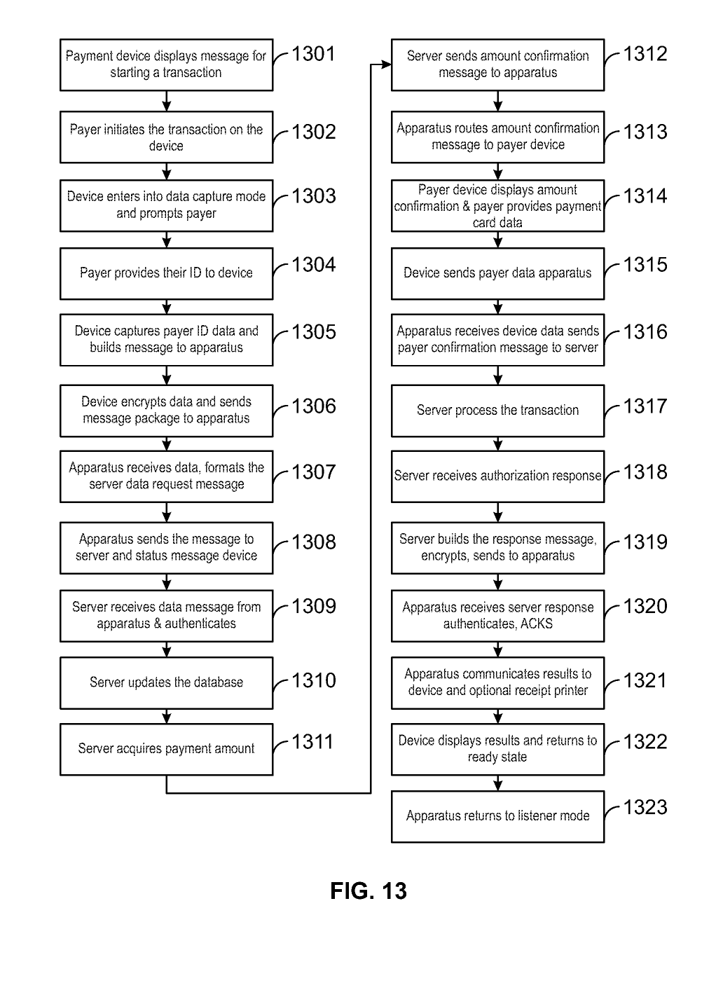

With reference now to FIG. 13, an exemplary flowchart is provided, for an example sequence of a card present transaction communication sequence with a device in a system environment in accordance with the present invention, such as FIG. 3. In the exemplary embodiment, the steps are performed as follows:

| Step | Task |
|---|---|
| 1301. | Device (1405, 1406, 1407) displays a message that informs the Payer to insert, wave |
| | or swipe their payment card, press a button or otherwise indicate the start of a |
| | transaction. |
| 1302. | Payer (1424) starts the transaction by interacting with device (1405, 1406, 1407). |
| 1303. | Device (1405, 1406, 1407) enters encrypting entry mode. Device (1405, 1406, 1407) |
| | instructs the payer (1424) to perform the payment data capture event such as inserting |
| | a credit card. |
| 1304. | Payer (1424) provides identification information and other data as needed. |
| 1305. | Device (1405, 1406, 1407) formats a message (1410, 1412, 1414) to apparatus (1403) |
| | including data such as date and time stamp, location, payer (1424) identifying data, |
| | and device (1405, 1406, 1407) identifying data. |
| 1306. | Device (1405, 1406, 1407) encrypts payer's (1424) captured data and other data and |
| | sends message (1410, 1412, 1414) to apparatus (1403). |
| 1307. | Apparatus (1403) receives device (1405, 1406, 1407) message (1410, 1412, 1414), |
| | parses the data, validates the message and formats a message for server (1401). |
| 1308. | Apparatus (1403) sends the message (1416) to server (1401) and a status message |
| | (1409, 1411, 1413) to device (1405, 1406, 1407). Server (1401) message may |
| | include device (1405, 1406, 1407) identification data such as the serial number of |
| | device (1405, 1406, 1407) used for capturing payer's (1424) data entry or the current |
| | default port (508, 509, 510, 511, 512). Device (1405, 1406, 1407) may display a |
| | status for the payer (1424). |
| 1309. | Server (1401) receives the message (1416), authenticates it and extracts the payload. |
| 1310. | Server (1401) updates the transaction and device databases (1421) (Transaction |
| | date/time, etc. No sensitive data is retained.) |
| 1311. | Server (1401) acquires payment amount based on the payer (1424) and device (1405, |
| | 1406, 1407) identification data. |
| 1312. | Server (1401) formats an amount confirmation request message (1417) and sends |
| | message to apparatus (1403). |
| 1313. | Apparatus (1403) parses and authenticates server (1401) message (1417), formats a |
| | message (1409, 1411, 1413) and sends message to device (1405, 1406, 1407). |
| 1314. | Device (1405, 1406, 1407) displays a message requesting payer (1424) confirmation. |
| | Payer (1424) confirms amount and provides payment card data. |
| 1315. | Device (1405, 1406, 1407) formats, encrypts a message (1410, 1412, 1414) and sends |
| | it to apparatus (1403) including payment card data, device (1405, 1406, 1407) |
| | identifying data, date and time stamps and other data as needed. |
| 1316. | Apparatus (1403) receives device (1405, 1406, 1407) confirmation and payment data |
| | message (1410, 1412, 1414) formats a server (1401) message (1416) and sends the |
| | message to server (1401). |
| 1317. | Server (1401) processes the payment transaction (e.g. an authorization)—sends the |
| | authorization request (1418) to the payment network (1422). |
| 1318. | Server (1401) receives the authorization response (1419). |
| 1319. | Server (1401) builds the authorization results message (1417) and sends it to |
| | apparatus.(1403) |
| 1320. | Apparatus (1403) receives the response (1417) from server (1401), authenticates, |
| | extracts payload, and ACKS (1416) server (1401). |
| 1321. | Apparatus (1403) sends transaction result message (1409, 1411, 1413) including data |
| | such as status of transaction and authorization code to device (1405, 1406, 1407). |
| 1322. | Device (1405, 1406, 1407) informs payer (1424) of the results of the authorization |
| | such as approved or declined. |
| 1323. | Apparatus (1403) returns to listener mode waiting for the next message (1410, 1412, |
| | 1414) from device (1405, 1406, 1407) or message (1417) server (1401). |

The above-mentioned steps are provided as exemplary. Steps can be eliminated, combined, or added without departing from the invention. Moreover, in certain embodiments, steps can be performed in a different order without departing from the invention.

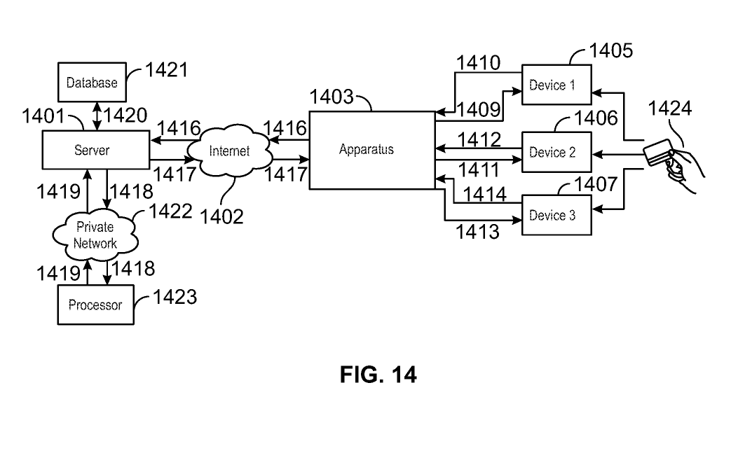

With reference now to FIG. 14, there is shown another exemplary system environment for electronic payment transactions in accordance with the present invention. The system includes a DCM apparatus 1403, in accordance with the present invention, is installed and communicatively connected to peripheral devices 1405, 1406, 1407, in order to isolate the local environment from transaction data, device operation and device management. Apparatus 1403 further isolates from transaction data the local network and its workstations.

The apparatus 1403 communicates through an Internet connection with server 1401 and through USB or RS232 connections communicates with devices 1405, 1406 and 1407. In the example, the Internet connection 1402 can be wired or wireless Ethernet or other connection type or protocol. Communication between apparatus 1403 and server 1401 can be via a private network or other network such as cellular service. Devices 1405, 1406, 1407 may be a such as multi-function POS device, PIN pad, card reader, signature capture device, printer, check scanner, printer or other peripheral used in a transaction processing system. Apparatus 1403 is configured to execute software comprising an operating system, a plurality of applications, communication port management software, and device drivers.

Any of devices 1405, 1406, 1407 sends a request 1410, 1412, 1414 to apparatus 1403 to initiate a transaction. Alternatively, server 1401 sends an initiation message 1417 to apparatus 1403. The request includes data necessary for software executing in apparatus 1403 to initiate the transaction includes such as merchant ID, date and time. On receipt of a valid request, apparatus 1403 formats messages 1409, 1411, or 1413 to be sent to a peripheral device 1405, 1406, or 1407. The target device 1405, 1406, 1407 receives message 1409, 1411, 1413 and performs interactions with a payer (1424) to capture additional data. The additional data comprises data such as payment credit card data from payer (1424), personal identification number (PIN), electronic signature, transaction amount, and responses to marketing queries. Upon completion of the capture of the additional data, the device formats a message 1410, 1412, 1414 and sends message to apparatus 1403. The message or data therein may be encrypted. Data specific to the device such as device ID, date, time, and other data needed to manage the device or process the transaction may be included in the message.

On receipt of the device message 1410, 1412, 1414, apparatus 1403 parses the message and validates the data, and determines if the transaction can continue. At this time, if there is any reason why the transaction cannot continue, apparatus 1403 may respond to device 1405, 1406, 1407 with an error condition. Given the transaction can continue, apparatus 1403 formats a server message 1416. Said message comprises payment data, authentication data, apparatus ID, apparatus firmware revision, and other data necessary for the transaction. The message 1416 or portions thereof may be encrypted by apparatus 1403 including but not limited to, individual data elements, multiple data elements, and the entire message. Apparatus 1403 sends the message 1416 to server 1401. A protocol such as PCT, SSL or TLS may be used for message security. Upon receipt, server 1401 parses the message 1416, determines source and type of message, and processes the message to facilitate completion of the transaction. Server 1401 may decrypt the message or portions thereof. Processing may include authentication using any of data from apparatus 1403, any of devices 1405, 1406, 1407, and payer 1424 provided data used in the transaction.

Server 1401 may perform local processing such as querying and/or updating 1420 a database 1421, verifying identifying data from any of apparatus 1403 and/or devices 1405, 1406, 1407, authorization, fraud checking, and other related actions. If server 1401 determines there is any reason to prevent the transaction from being further processed, server 1401 may respond to apparatus 1403 with an error condition message. Additionally server 1401 may forward all or a portion of the message 1418 to one or more entities such as a payment processor 1423 or other third parties via network 1422. Processor 1423 receives message 1418, and takes further action based on the contents of the message 1418. Said actions will include such as verifying the message 1418 data integrity, verifying sender identity, verifying merchant identity data, executing payment authorization, fraud checking, and database updates. Upon completion of processing the message 1418, Processor 1423 responds with a result message 1419.

Server 1401 receives message 1419, and processes the message. Server 1401 may decrypt all or portions of message 1419 prior to processing said message. Server 1401 updates database 1421 based on the contents of message 1419. Server 1401 formats a response 1417 to apparatus's 1403 message 1416. The message 1417 and portions thereof may be encrypted by server 1401 including but not limited to, individual data elements, multiple data elements, and the entire message. Server 1401 may add data to the message 1419 including but not limited to the transaction processing result, configuration data 519 for any of apparatus 1403 or devices 1405, 1406, 1407, and other data needed to complete the transaction. Server 1401 sends the response message 1417 to apparatus 1403.

Upon receipt of message 1417, apparatus 1403 processes the message and determines the transaction processing result. Apparatus formats a completion message 1409, 1411, 123 and transmits the one or more messages to devices 1405, 1406, 1407. Upon completion of the transaction, apparatus 1403 resumes “listening mode” and waits for a message from any of server 1401 or devices 1405, 1406, 1407.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

1. A device communication management (DCM) apparatus, comprising:
a first communication port in operative communication with a workstation;
a second communication port in operative communication with a peripheral device;
a network communication port in operative communication with a remote server;
a controller in operative communication with the first communication port, the second communication port, and the network communication port; and
a non-transitory storage medium in operative communication with the controller and containing a set of instructions, the set of instructions causing the controller to perform the following:
receive an electronic transaction request through any of the first communication port, second communication port, or network communication port;
in response to receiving the electronic transaction request, format a data capture request;
transmit the data capture request through the second communication port;
receive transaction data through the second communication port;
isolate the transaction data within the non-transitory storage medium such that the transaction data is inaccessible through the first communication port;
encrypt a transaction processing request in which the transaction processing request is based on the received data;
transmit the encrypted transaction processing request through the network communication port;
receive a reply to the transaction processing request; and
transmit a processing status message through the first communication port and/or the second communication port.

2. The DCM apparatus as defined in claim 1, further comprising a housing that retains the first communication port, the second communication port, the network communication port, the controller, and the non-transitory storage medium.

3. (canceled)

4. The DCM apparatus as defined in claim 1, wherein the non-transitory storage medium containing a second set of instructions, the second set of instructions causing the controller perform the following:
receive an update file through the network communication port from a remote server;
in response to receiving the update file, format an update message for either the peripheral device or the workstation;
transmit the update message to the workstation through the first communication port or to the peripheral device through the second communication port;
receive an acknowledgement from the workstation through either the first communication port or from the peripheral device through the second communication port;
format and encrypt a confirmation message;
transmit the encrypted confirmation message through the network communication port to the remote server; and
receive an acknowledgement response through the network communication port from the remote server.

5. The DCM apparatus as defined in claim 4, wherein the second set of instructions require that the update message contains an executable code file and/or configuration data, prior to formatting the update message or transmitting the update message.

6. The DCM apparatus as defined in claim 4, wherein the second set of instructions require that the update file is encrypted, from which the update message contains data for authentication.

7. A method of managing device communications for payment transaction, comprising:
receiving an electronic transaction request through a first communication port of a device communication management (DCM) apparatus;
in response to receiving the electronic transaction request, formatting a transaction data capture request;
transmitting the transaction data capture request through a second communication port of the DCM apparatus;
receiving transaction data through the second communication port;
isolating the transaction data such that the transaction data is inaccessible through the first communication port;
encrypting a transaction authorization request based on the transaction data;
transmitting the encrypted transaction authorization request through a network communication port of the DCM apparatus; and
in response to receiving a reply to the transaction authorization request, transmitting a transaction status message through the first communication port.

8. The method as defined in claim 7, wherein the transaction data capture request is transmitted to the point-of-sale device through the second communication port.

9. The method as defined in claim 7, wherein the transaction data is received from a peripheral device through the second communication port.

10. The method as defined in claim 7, wherein:
the first communication port is in operative communication with a workstation;
the second communication port is in operative communication with a peripheral device; and
the network communication port is in operative communication with a remote server.

11. The method as defined in claim 7, further-comprising:
receiving an update file through the network communication port from a remote server;
in response to receiving the update file, formatting an update message for a workstation or peripheral device communicatively connected either through the first communication port or the second communication port;
transmitting the update message to the workstation or peripheral device through either the first communication port or the second communication port, to which the workstation or peripheral device is connected;
receiving an acknowledgement from the workstation or peripheral device through either the first communication port or the second communication port, to which the workstation or peripheral device is connected;
formatting and encrypting a confirmation message;
transmitting the encrypted confirmation message through the network communication port to the remote server; and
receive an acknowledgement response through the network communication port from the remote server.

12. The method as defined in claim 11, wherein the update message must contain an executable code file and/or configuration data, prior to formatting the update message or transmitting the update message.

13-17. (canceled)
